(19) United States
(12) Patent Application Publication
(10) Pub. No.: US 2017/0347025 A1
(43) Pub. Date: Nov. 30, 2017

(54) USER-WEARABLE TYPE PHOTOGRAPHING DEVICE

(71) Applicant: TRINUS SYSTEMS INC., Dong-gu, Daegu (KR)

(72) Inventor: Ki Hwan PARK, Goyang-si, Gyeonggi-do (KR)

(21) Appl. No.: 15/537,664

(22) PCT Filed: Dec. 22, 2014
(86) PCT No.: PCT/KR2014/012637

§ 371 Date: Jun. 19, 2017

(51) Int. Cl. H04N 5/232; H04N 5/225; G01S 19/13

(52) U.S. Cl. CPC H04N 5/23238; H04N 5/23296; G01S 19/13; H04N 5/2257; H04N 5/23293

(57) ABSTRACT

The present invention relates to a user-wearable type photographing device, which enables, separately from visual observation of a police officer or private security guard who is on patrol to preventing crime, image data related to a crime, an accident sign, a momentary crime, and an accident scene at the time of patrolling to prevent crime to be naturally acquired in a process of the crime-prevention patrol so that the acquired image data can be used in a future process of the handling and settlement of crimes and accidents. The user-wearable type photographing device according to the present invention comprises: a wearable case which has a lens hole and a microphone hole formed therein and is to be worn by a user; a camera module embedded in the wearable case and having a lens exposed to the outside through the lens hole; a microphone embedded in the wearable case and recording a voice through the microphone hole; an input unit having a plurality of buttons exposed to the outside of the wearable case to allow inputting of a signal for an operation and control of a photographing device comprising the camera module and the microphone; a control unit for controlling a general operation of the photographing device comprising the camera module and the microphone, according to an input signal of the input unit; a storage unit for storing image data photographed through the camera module, voice data recorded through the microphone, and various other data; and a GPS module for acquiring GPS location information of the photographing device comprising the camera module and the microphone, and providing, as metadata, the acquired GPS information to the image data acquired by the camera module.

### TECHNICAL FIELD

The present invention relates to a user-wearable type photographing device, and more particularly, to a user-wearable type photographing device capable of naturally acquiring image data of a sign of a crime or an accident during a security patrol, an instant crime and an accident scene without visual surveillance by a police officer or a private security guard such that the image data can be used in processing and solving a crime and an accident later.

### BACKGROUND ART

As population density in cities increases, the necessity and importance of patrol services for fire, crime prevention and parking control are increasing.

Accordingly, police officers more frequently conduct security patrol activities in their districts. In addition, security guards patrol an area to prevent crimes and accidents at night in apartment complexes, office buildings and government offices.

However, such security patrol activities are totally dependent on visual surveillance by police officers or private security guards at the time of the security patrol activities. As a result, if police officers or private security guards fail to detect any signs of crimes and accidents at the security patrol site or fail to recognize an instant crime or the scene of an accident, they cannot secure any relevant data for further processing of the crime or accident.

In particular, considering that the security patrol activities should be conducted more closely in blind areas which CCTV cameras cannot cover, there is a great need for a means to collect relevant data that enables the crime and accident signs at the time of security patrol or the instant crime or accident scene to be confirmed later, apart from visual surveillance by police officers or private security guards at the patrol site.

### DISCLOSURE

### Technical Problem

Therefore, the present invention has been made in view of the above problems, and it is one object of the present invention to provide a user-wearable type photographing device capable of naturally acquiring image data of a sign of a crime or an accident at the time of security patrol, an instant crime and an accident scene without visual surveillance by a police officer or a private security guard such that the image data can be used in handling and resolving the crime and the accident later.

### Technical Solution

In accordance with one aspect of the present invention, provided is a user-wearable type photographing device including a wearable case provided with a lens hole and a microphone hole and configured to be worn by a user, a camera module provided in the wearable case and including a lens exposed to an outside through the lens hole, a microphone provided in the wearable case and configured to record voice through the microphone hole, an input unit for inputting a signal for operation and control of the photographing device including the camera module and the microphone, the input unit including a plurality of buttons exposed to an outside of the wearable case, a control unit for controlling overall operation of the photographing device including the camera module and the microphone according to the input signal of the input unit, a storage unit for storing image data photographed through the camera module, audio data recorded through the microphone, and various other data, and a GPS module for acquiring GPS position information about the photographing device including the camera module and the microphone and providing the image data acquired by the camera module with the acquired GPS information as metadata.

The lens hole and the microphone hole are formed in the same surface of the wearable case, a recording button of the plurality of buttons of the input unit is exposed through the surface having the lens hole and the microphone hole, and the camera module and the microphone simultaneously operate according to an ON operation of the recording button to acquire the image data and the audio data, respectively.

The camera module acquires the image data in a viewing angle range of 90° to 150°.

The photographing device further includes a gyro sensor installed in the wearable case to acquire a direction of body movement of the user wearing the wearable case, wherein the control unit adjusts a viewing angle of the camera module in a direction opposite to the direction of body movement of the user according to a signal input through the gyro sensor such that image data in a direction opposite to a direction in which the user gazes is acquired through the camera module.

The photographing device further includes a communication module for transmitting the image data, the audio data, the metadata, and the various other data stored in the storage unit to an external receiving destination.

The photographing device further includes a pair of display units provided on an outer side of the wearable case in an exposed state to indicate on/off states of power of the photographing device and on/off states of operations of the camera module and the microphone, respectively.

### Advantageous Effects

As apparent from the fore-going, according to embodiments of the present invention, image data of a sign of a crime or an accident at the time of security patrol, an instant crime and an accident scene is naturally acquired without visual surveillance by a police officer or a private security guard, and therefore can be used in handling and resolving the crime and the accident later.

### DESCRIPTION OF DRAWINGS

FIG. 1 is a perspective view illustrating a user-wearable type photographing device according to an embodiment of the present invention.

FIG.2 is a block diagram illustrating an electrical configuration of a user-wearable type photographing device according to an embodiment of the present invention.

FIG. 3 is a block diagram illustrating an electrical configuration of a user-wearable type photographing device according to another embodiment of the present invention.

### BEST MODE

Hereinafter, a user-wearable type photographing device according to an embodiment of the present invention will be described in detail with reference to the accompanying drawings.

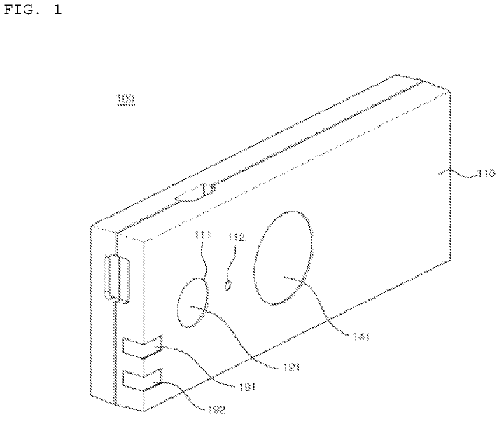

FIG. 1 is a perspective view illustrating a user-wearable type photographing device according to an embodiment of the present invention, and FIG.2 is a block diagram illustrating an electrical configuration of a user-wearable type photographing device according to an embodiment of the present invention.

As shown in the figures, a user-wearable type photographing device 100 (hereinafter, referred to as a “photographing device”) according to an embodiment includes a wearable case 110, a camera module 120, a microphone 130, a control unit 150, a storage unit 160, and a GPS module 170. The user-wearable type photographing device 100 may further include a communication module 180 and display units 191 and 192.

The wearable case 110 defines the outer appearance of the photographing device 100. The wearable case 110 is provided with a lens hole 111 and a microphone hole 112. In addition, the wearable case 110 includes a wearable structure allowing the user to wear the wearable case. Various structures such as a hook, a clip, and a Velcro fastener can be used as the wearable structure. In this embodiment, detailed illustration and description of the wearable structure will be omitted.

While it is illustrated in this embodiment that the lens hole 111 and the microphone hole 112 are formed in the same surface of the wearable case 110, this configuration is merely intended to more effectively acquire image data and audio data about a recorded scene. The lens hole 111 and the microphone hole 112 are not necessarily formed in the same surface of the wearable case 110.

The camera module 120 is embedded in the wearable case 110 and the lens 121 of the camera module 120 is exposed to the outside through the lens hole 111 of the wearable case 110. The camera module 120 may acquire image data in a viewing angle range of 90° to 150°. Further, the camera module 120 may acquire image data in a viewing angle range of 30° to 180°.

The microphone 130 is embedded in the wearable case 110 and records voice through the microphone hole 112 of the wearable case 110.

The input unit 140 includes a plurality of buttons that are exposed to the outside of the wearable case 110. A signal for operation and control of the camera module 120 and the microphone 130 and a signal for overall operation and control of the photographing device 100 are input through the input unit 140. While it is illustrated in this embodiment that the recording button 141 among the buttons of the input unit 140 is installed so as to be exposed through one surface in which the lens case 111 and the microphone hole 112 of the wearable case 110 are formed, embodiments of the present invention are not limited thereto.

That is, since the camera module 120 and the microphone 130 face forward of the wearable case 110 with respect to the user, the recording button 141 for operation of the camera module 120 and the microphone 130 is installed on one surface at the front of the wearable case 110 to allow the user to simply operate the button. The recording button 141 is not necessarily exposed through the one surface in which the lens case 111 and the microphone hole 112 are formed.

The camera module 120 and the microphone 130 simultaneously operate according to the ON operation of the recording button 141 to acquire image data and audio data, respectively.

The control unit 150 controls overall operation of the photographing device 100 including the camera module 120 and the microphone 130 according to an input signal of the input unit 140.

The storage unit 160 stores data of images photographed through the camera module 120, audio data recorded through the microphone 130, and various other data.

The GPS module 170 acquires GPS position information and provides the image data acquired by the camera module 120 with the acquired GPS information as metadata.

The communication module 180 transmits the video data, audio data, metadata, and various other data stored in the storage unit 160 to an external receiving device such as a PC or a smartphone. The communication module 180 may be a USB port. Various wired/wireless communication devices may also be used as the communication module 180 as long as the data in the storage unit 160 can be transmitted to such external receiving devices.

The display units 191 and 192 are installed on the outer side of the wearable case 110 in an exposed state to indicate on/off states of power of the photographing device 100 and on/off states of operations of the camera module 120 and the microphone 130, respectively. While the display units 191 and 192 are illustrated in this embodiment as being LEDs, embodiments of the present invention are not limited thereto.

According to the above configuration, when the user performs security patrol, while wearing the photographing device 100 with the recording button 141 turned on, image data about the periphery of the route of security patrol is acquired. The image data acquired in this way is stored and can be used as data for solving and processing a crime and an accident occurring on the route of a security patrol by determining whether the data is relevant to a crime or an accident.

Since the image data acquired through the photographing device 100 includes GPS information as metadata, necessary image data may be more easily retrieved from the image data of the photographing device 100 based on the GPS information, which is metadata, and utilized when the image data of the photographing device 100 is needed to solve and process various crimes and accidents.

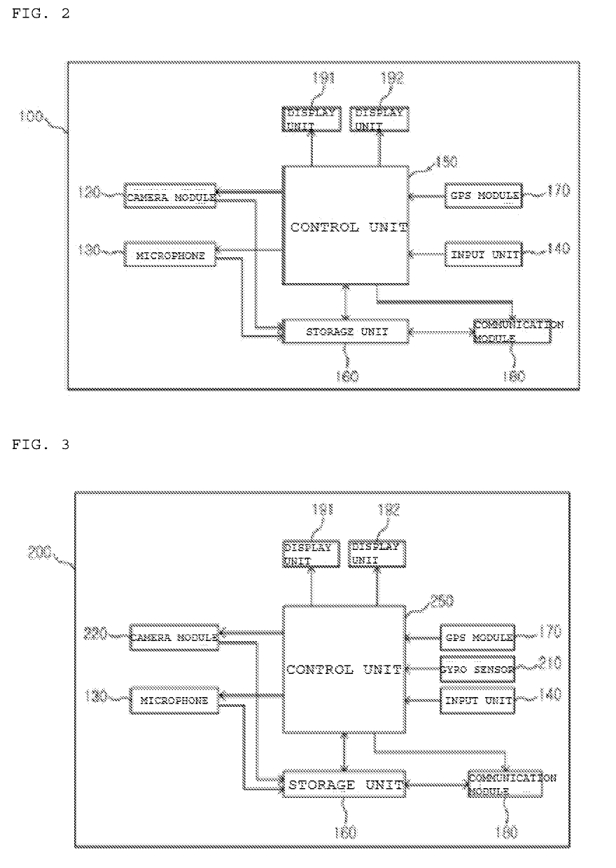

Next, a user-wearable type photographing device according to another embodiment of the present invention will be described with reference to FIG. 3.

The user-wearable type photographing device 200 (hereinafter, referred to as “photographing device”) according to this embodiment is different from the photographing device 100 according to the embodiment of FIGS. 1 and 2 in that the photographing device 200 further includes a gyro sensor 210 and also includes a control unit 250 and a camera module 220, which are associated with the gyro sensor 210. In this embodiment, the gyro sensor 210, the control unit 250, and the camera module 220 will be mainly described. In addition, the remaining components that are the same as those of the photographing device 100 according to the embodiment of FIGS. 1 and 2 will be assigned the same reference numerals, and detailed description thereof will be omitted.

As shown in the figure, the photographing device 200 includes a gyro sensor 210 installed in the wearable case 110 to acquire a direction of body movement of the user wearing the wearable case 110.

The control unit 250 adjusts the viewing angle of the camera module 220 in a direction opposite to the direction of body movement of the user according to a signal input through the gyro sensor 210, and thus image data in the direction opposite to the direction in which the user gazes is acquired through the camera module 220.

This serves to enable the camera module 220 and the microphone 130 of the photographing device 200 to assist the user in performing security patrol as the user cannot visually check a spot on the opposite side of the place which the user watches, such that a situation that was unnoticed during the patrol operation can be checked through image data and audio data of the recorded video and relevant data can be utilized when necessary.

As can be seen from the embodiments of FIGS. 1 to 3, the user-wearable type photographing device according to the present invention may naturally acquire image data of a sign of a crime or an accident at the time of security patrol, an instant crime and an accident scene without visual surveillance by the site by a police officer or a private security guard such that the image data can be used in handling and solving a crime and an accident later.

Although embodiments of the present invention have been disclosed for illustrative purposes, it will be understood by those of ordinary skill in the art that various changes in form and details may be made therein without departing from the spirit and scope of the present invention.

### INDUSTRIAL AVAILABILITY

The present invention can be widely used in various kinds of photographing devices.

1. A user-wearable type photographing device comprising:
a wearable case provided with a lens hole and a microphone hole and configured to be worn by a user;
a camera module provided in the wearable case and comprising a lens exposed to an outside through the lens hole;
a microphone provided in the wearable case and configured to record voice through the microphone hole;
an input unit for inputting a signal for operation and control of the photographing device comprising the camera module and the microphone, the input unit comprising a plurality of buttons exposed to an outside of the wearable case;
a control unit for controlling overall operation of the photographing device comprising the camera module and the microphone according to the input signal of the input unit;
a storage unit for storing image data photographed through the camera module, audio data recorded through the microphone, and various other data; and
a GPS module for acquiring GPS position information about the photographing device comprising the camera module and the microphone and providing the image data acquired by the camera module with the acquired GPS information as metadata.

2. The photographing device according to claim 1, wherein:
the lens hole and the microphone hole are formed in the same surface of the wearable case; and
a recording button of the plurality of buttons of the input unit is exposed through the surface having the lens hole and the microphone hole, and the camera module and the microphone simultaneously operate according to an ON operation of the recording button to acquire the image data and the audio data, respectively.

3. The photographing device according to claim 1, wherein the camera module acquires the image data in a viewing angle range of 90° to 150°.

4. The photographing device according to claim 3, further comprising:
a gyro sensor installed in the wearable case to acquire a direction of body movement of the user wearing the wearable case,
wherein the control unit adjusts a viewing angle of the camera module in a direction opposite to the direction of body movement of the user according to a signal input through the gyro sensor such that image data in a direction opposite to a direction in which the user gazes is acquired through the camera module.

5. The photographing device according to claim 1, further comprising:
a communication module for transmitting the image data, the audio data, the metadata, and the various other data stored in the storage unit to an external receiving destination.

6. The photographing device according to claim 1, further comprising:
a pair of display units provided on an outer side of the wearable case in an exposed state to indicate on/off states of power of the photographing device and on/off states of operations of the camera module and the microphone, respectively.
